(19) United States
(12) Patent Application Publication
(10) Pub. No.: US 2002/0037361 A1
(43) Pub. Date: Mar. 28, 2002

(54) Method of colouring an electronic device, in particular a personal computer or a computer-related device

(75) Inventor: Bryan Goddert, Valby (DK)

Correspondence Address: MERCHANT & GOULD PC, P.O. BOX 2903, MINNEAPOLIS, MN, 55402-0903, US

(73) Assignee: IT Colors ApS, Hedehusene (DK)

(21) Appl. No.: 10/000,983

(22) Filed: Oct. 30, 2001

Related U.S. Application Data
(63) Continuation of application No. 09/412,676, filed on Oct. 5, 1999.

(30) Foreign Application Priority Data
Jul. 1, 1999 (EP) 99202131.1

(51) Int. Cl. B05D 1/36; B05D 7/00; B05D 1/02; B05D 5/06

(52) U.S. Cl. 427/58; 427/421; 427/407.1

(57) ABSTRACT

Many pieces of electronic office equipment, in particular IT products, such as personal computers and associated devices, telephone sets, printing machines, photocopy machines, facsimile machines, etc. are produced with casings or cabinets in a somewhat standardised coloured plastic or the like. The colour of this casing is usually in a nuance of light grey, and varies only slightly from manufacturer to manufacturer. However, by the present invention a method is provided, by the use of which IT products and the like subsequent to their manufacture can be applied with a colour of the choice of the customer.

The present invention relates to a method of colouring at least an exterior surface of an electronic device, in particular a personal computer or a computer-related device, such as printers, PC screens and the like.

Many pieces of electronic office equipment, in particular IT products, such as personal computers and associated devices, telephone sets, printing machines, photocopy machines, facsimile machines, etc. are produced with casings or cabinets in a somewhat standardised coloured plastic or the like. The colour of this casing is usually in a nuance of light grey, and varies only slightly from manufacturer to manufacturer.

The casings or cabinets are typically made in an elastomeric material a plastic mould. The colour of the casing is given by the colour of the elastomeric material used in the moulding, and is usually chosen to be a neutral colour for electronic equipment intended for office use. For example computers, in particular PC's this neutral colour design has been the order of the day for all the manufactures since the entry of the personal computer into the office environment.

This relation is hardly changed since then and the IT products, i.e. the PC cabinet, the screen, the mouse and the keyboard are produced in the same grey colour scheme.

This means that the colour of the equipment is not an issue when the customer is to choose the type of equipment which in turn means that the manufactures and retailers do not need to keep a stock of items in different colour. This means that a high number of similar items can be produced resulting in lower manufacturing and storage costs.

The colour can vary slightly from manufacturer to manufacturer, and in the resent years also electronic equipment such as computer screens or cabinets for PC's is starting to appear on the market, e.g. portable computers are now being produced with a casing moulded in other colours, such as dark blue or black. But common for these solutions is that a particular type or model is produced in one colour only. The colour is given by the chose of colour pigment added to the material in the plastic moulding. The amount of different colours available could be somewhat limited as the elastomeric material must also be suitable for the required plastic moulding process, and since the variety of colour in any case will result in higher production costs. Therefore, the manufactures of electronic office equipment only produce products in a few different colours, if any colour variation at all. These types of products typically only have a short life cycle and varieties in their production can cause a significant increase in the production costs which then would be reflected in the retail price.

However, by the present invention it is realised that these circumstances can be altered by the provision of a method of colouring at least an exterior surface of an electronic device, in particular a personal computer or a computer-related device, such as printers, PC screens and the like, comprising the steps of preparing the exterior surface or surfaces of the casing of the device for the application of coating by cleaning said surface or surfaces, applying at least one priming first coating to the exterior surface or surfaces, after the drying of the first coating, after the drying of the first coating, applying one or more layers of coloured coating onto the primed surface or surfaces, preferably two layers applied in succession by spraying on one layer at the time and leaving it to dry before the application of the next, and applying by spraying or the like a final transparent coating layer on the top of the colour coating or coatings for the protection of the colour-coated exterior surface or surfaces.

By a method according to the invention IT products or other devices can be provided with any colour according to the liking of the owner or user. By applying the colour onto the exterior surface of the moulded part or parts of a particular device, the advantages of uniform manufacturing is withheld, since the parts can all be manufactured in the same colour or even in the plastic material most suitable for the plastic moulding irrespective of the colour that such a material happens to have. This might even result in a reduction of the cost of manufacture.

By a method according to the invention IT products or other electronic devices intended for office use can be provided in a different colour or colours according to the customers desire e.g. as an additional option at the point of sale. This means that neither the manufacturer, the regional storage or the retailer need to keep at least a minimum stock of products in different colours. By the separate subsequent colouring process according to the invention, this paves the way for the practical provision of IT products, such as PC's and accessories therefore, to be offered to the customers.

In a preferred embodiment, the priming first coating is applied by spraying and is a primer based on xylene. Moreover, the primer is containing a portion of light aromatic solvent naphta, arcrylates and/or isocyanates. A light flowing, high viscous primer is hereby provided which is particularly suitable as a primer for the use on a surface of an elastomeric material, i.e. the surfaces of casings, cabinets keyboards or buttons of IT products and the like. The primer is preferably diluted by a thinner. The exact portions of the materials of the primer can be adapted so as to optimally stick to the type of surface material.

In an embodiment of the invention, the device initially is disassembled prior to the cleaning that comprises a degreasing of the exterior surface or surfaces of the casing of the device, said degreasing preferably be carried out by the application of a solvent. Furthermore, at least the casing of the device is subjected to the colouring process, and where the device is reassembled after the protective layer is applied and whereafter the reassembled device is prepared for shipment by a process of packaging of the device. By this embodiment, the method according to the invention can also be carried out on existing products, second hand products, etc. The service of colouring can thus be offered as an option at the point of sale providing the product with a colour as chosen by the customer.

In a further embodiment of a method according to the invention, a semi-transparent film provided with a pattern is applied and that the pattern is deposited on the surface after the application of the coloured coatings and before the application of the final, protective, transparent coating. By a method according to this embodiment of the present invention, further decorative effects such as specially designed patterns in different colours, e.g. a company logo, can be applied to the product. This has not only an aesthetic effect but also applies an individual marking to the product, e.g. a portable PC, providing the product with an identification preventing theft of the product, as the product is easily identifiable.

The preparatory cleaning involves preferably a light grinding of the exterior surface, whereby the texture of the surface is slightly roughened so that the primer sticks better to the plastic surface, without destroying the product design features.

The invention also concerns the use of the method according to the first aspect of the invention, whereby one or more devices, such as a computer cabinet, a computer screen, a keyboard, a mouse and/or a printer in relation to a personal computer package is applied with a colour coating of the choice of the consumer. By putting the method in use for this, more aesthetically attractive computer products can be provided, as the colour and thus the visual appearance in an office or domestic environment can be improved, as the colour can be chosen in accordance with the existing colour scheme of the surrounding environment. This means that computer equipment by the use of a method according to the invention, by the customer can be specified both in technical terms and in terms of appearance.

The method according to an embodiment of the invention is in a preferred use carried out, whereby at least one device in relation to a personal computer package is applied with a colour coating and a pattern in a distinguished, easily recognisable design in a different colour, such as a company logo or the like, is applied deriving from the film. Hereby, a company or an organisation can form a distinguished, individual appearance on their products by applying not only a colour but also a logo or a particular pattern on their computer products. This can also constitute a sort of anti-theft measure, as e.g. a portable computer (a so-called notebook or laptop) can be individual in its look and therefore less attractive for an opportunist to take with him.

In another use of the method according to the invention, a satellite dish receiver for domestic purposes is applied with a colour coating. Hereby, a colour can be applied that blends in with the surroundings making the satellite dish less obscuring to the eye.

The invention will be described more detail below with reference to the accompanying drawings, in which

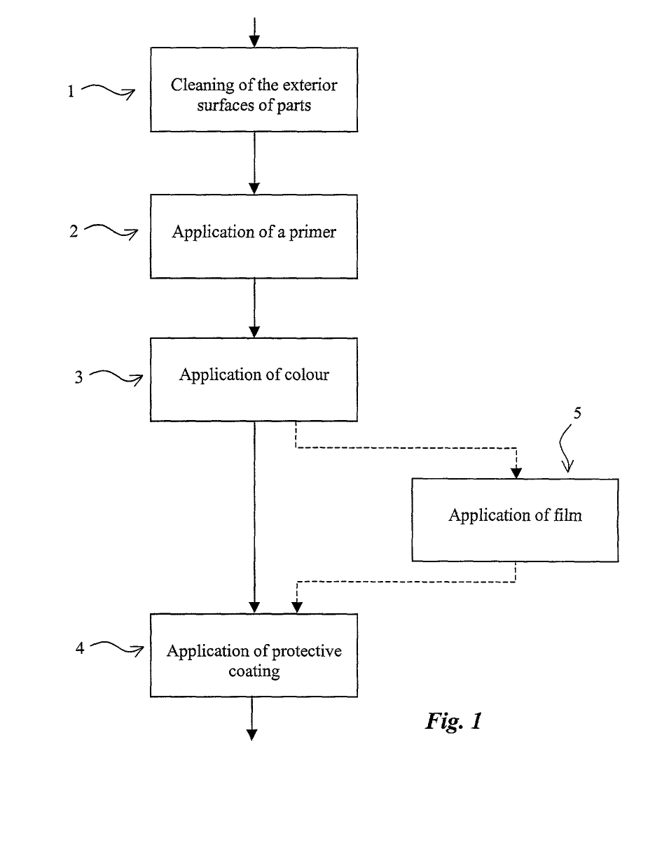

FIG. 1 is a activity diagram of a method according to a first embodiment of the invention, and

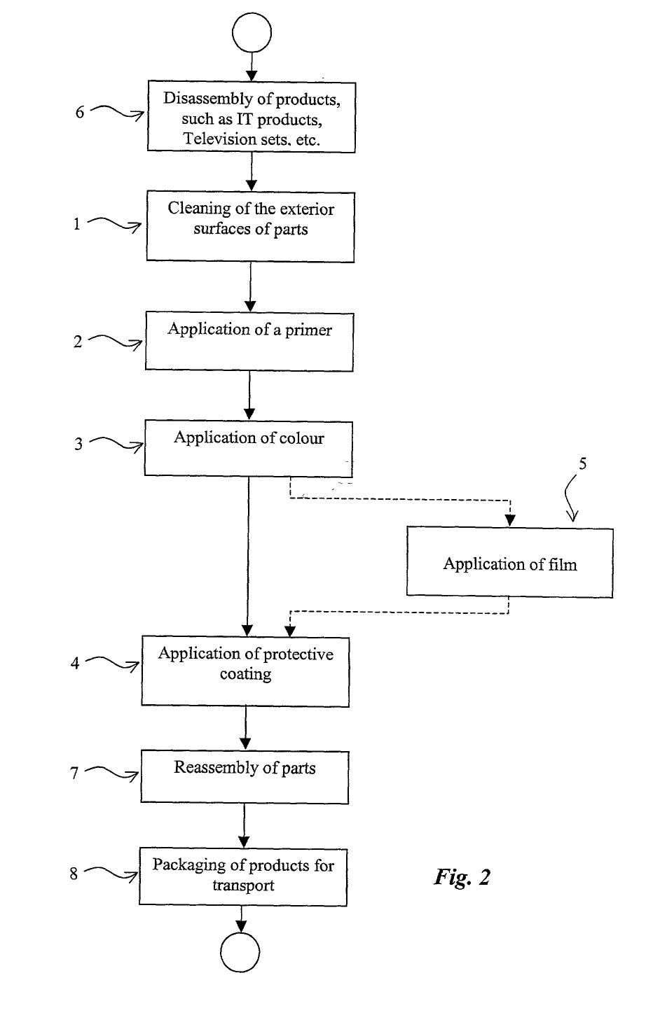

FIG. 2 is a activity diagram of a second embodiment of a method according to the invention.

In FIG. 1 is shown a method according to the basic principle of the colouring process of the invention. Firstly, in the colouring process for colouring the exterior surface of an electronic device, the exterior surfaces of the parts are cleaned in order to degrease the surface preparing it for receiving a first layer of paint. The cleaning process (indicated by 1 in the activity diagram of FIG. 1 and 2) can also involve a cleaning removing dirt, a light grinding in order to roughen the surface making it more susceptible to the reception of a layer of paint.

The first layer applied is a primer (indicated by 2 in the activity diagram of FIG. 1 and 2). The primer is sprayed onto the surface. In order to suit the primer to the surface, the composition is adapted to the individual type of plastic surface that the primer is to be applied on. The primer must be thin with a high viscosity in order to coat the surface without any substantially changes to the dimensions and the textures of the part, so that a reassembly and the overall design appearance is not compromised. Moreover, the primer must stick firmly to the surface in order to provide a solidly fixed first coating to the surface, and on the other hand provide a satisfying outer surface whereon the next layer of coating can solidly stick to.

In order to meet these criteria, the primer by a preferred embodiment is containing xylene, light aromatic solvent napha, arcrylates and isocyantes. The amount of each of these components is chosen in order to provide the most optimal result of the surface to be coated. The primer is diluted by a thinner of the type that is universally usable for two component lacquers.

In order to achieve a uniform coating as thin as possible, the primer is sprayed onto the surface.

The primer is left to dry, whereafter preferably two layers of colour are applied (indicated by 3 in the activity diagram of FIG. 1 and 2). The paint used for the colouring is the same or similar to the paint used for painting cars and the like. The composition of the primer is adapted to this type of coloured coating. This is beneficial in that a huge variety of colours are available, including also metallic variantes. The coloured coating is applied one layer at the time. After the application by spraying of the first of the colour layers, the layer is left to dry, typically for about an hour, whereafter the second layer is applied.

In an alternative embodiment the coloured layer could be a metallic powder deposited on the primer, e.g. a spray of gold particles applied to the surface.

When the application of colour coating layers is finished the colour is sealed by a final, protective coating that is transparent, as indicated by reference number 4. This transparent lacquer prevents cracks etc. in the surface of the coloured coating and selves as well as an optical shield against fading in the colours due to sunlight.

After the application of colour and before the application of the protective, final coating a film carrying a pattern can optionally be applied, as indicated by reference number 5. Hereby, a company logo, tiger stripes, etc. can be applied on the top of the coloured surface, creating a particular distinctive visual effect.

The method as displayed in FIG. 1 can be for instance carried out at the end of a production line, by the retailer, prior the putting the product up for sale. Alternatively, a method according to another embodiment of the invention, as displayed in FIG. 2, can be performed for instance on existing products, such as second hand products, or in a connection with the sale of the product, where the customer specified the colour.

The method then includes an initial disassembly of the relevant parts of the product (indicated in FIG. 2 by the reference 6), such as a computer screen, a cabinet, a keyboard or a computer mouse, and the parts that are selected for colouring, i.e. the parts carrying exterior surfaces are transferred to a cleaning process 1 and undergoes the colouring process as described above with reference to FIG. 1.

After the finishing coating of the transparent protective layer, the product is reassembled, as indicated by reference number 7, and preferably also enclosed in a protective packaging, protecting the product during storage and transport.

1. A method of colouring at least an exterior surface of an electronic device, in particular a personal computer or a computer-related device, such as printers, PC screens and the like, comprising the steps of
preparing the exterior surface or surfaces of the casing of the device for the application of coating by cleaning said surface or surfaces,
applying at least one priming first coating to the exterior surface or surfaces,
after the drying of the first coating, applying one or more layers of coloured coating onto the primed surface or surfaces, preferably two layers applied in succession by spraying on one layer at the time and leaving it to dry before the application of the next, and
applying by spraying or the like a final transparent coating layer on the top of the colour coating or coatings for the protection of the colour-coated exterior surface or surfaces.

2. A method according to claim 1, wherein the priming first coating is applied by spraying and is a primer based on xylene.

3. A method according to claim 2, wherein the primer further is containing a portion of light aromatic solvent naphta, arcrylates and/or isocyanates.

4. A method according to any of the claims 1 to 3, wherein the device initially is disassembled prior to the cleaning that comprises a degreasing of the exterior surface or surfaces of the casing of the device, said degreasing preferably be carried out by the application of a solvent.

5. A method according to claim 4, wherein at least the casing of the device is subjected to the colouring process, and where the device is reassembled after the protective layer is applied and whereafter the reassembled device is prepared for shipment by a process of packaging of the device.

6. A method according to any of the previous claims, wherein a semi-transparent film provided with a pattern is applied and that the pattern is deposited on the surface after the application of the coloured coatings and before the application of the final, protective, transparent coating.

7. A method according to claim 6, wherein the preparatory cleaning involves a grinding of the exterior surface.

8. Use of a method according to any of the previous claims, whereby one or more devices, such as a computer cabinet, a computer screen, a keyboard, a mouse and/or a printer in relation to a personal computer package is applied with a colour coating.

9. Use of a method according to claim 6, whereby at least one device in relation to a personal computer package is applied with a colour coating and a pattern in a distinguished, easily recognisable design in a different colour, such as a company logo or the like, is applied deriving from the film.

10. Use of a method according to any of the previous claims, whereby a satellite dish receiver for domestic purposes is applied with a colour coating.
